(19) United States
(12) Patent Application Publication
(10) Pub. No.: US 2002/0137424 A1
(43) Pub. Date: Sep. 26, 2002

(54) METHOD OF MANUFACTURING DISCHARGE DISPLAY DEVICES USING PLASMA ENHANCED VAPOR DEPOSITION

(76) Inventor: HIDEKI HARADA, AKASHI-SHI (JP)

Correspondence Address: STAAS & HALSEY LLP, 700 11TH STREET, NW, SUITE 500, WASHINGTON, DC, 20001, US

(21) Appl. No.: 09/289,579

(22) Filed: Apr. 12, 1999

(30) Foreign Application Priority Data
Jul. 7, 1998 (JP) 10-191273

(51) Int. Cl. H01J 9/24

(52) U.S. Cl. 445/24

(57) ABSTRACT

A fabricating method of a gas discharge display device having a dielectric layer spreading over an entire display area so as to cover electrodes arranged on a substrate, comprises the steps of arranging the electrodes on the substrate; and forming conformally the dielectric layer upon a surface of the substrate, on which the electrodes have been arranged, by the use of a plasma vapor deposition method.4. The fabricating method may further comprises the step of forming a light shielding layer between the electrodes excluding at least the surface discharge gap within the display area before forming the dielectric layer.

### BACKGROUND OF THE INVENTION

1. Field of the Invention

This invention relates to a manufacturing method of a gas discharge display device having an electrode group and a dielectric layer for covering thereof for generating a discharge in a plasma display panel (PDP) and a plasma addressed liquid crystal (PALC), etc.

PDPs are getting popular as a large display device of television picture and computer output upon the occasion of the achievement of the colored PDP.

2. Description of the Related Arts

As colored displays there have been commercially in production AC type PDPs of a three-electrode surface discharge structure, which is provided with a pair of main electrodes, i.e. a first electrode and a second electrode, for sustaining lighting for the display of each line, and an address electrode, i.e. a third electrode, for each row. In the displaying, the AC type PDPs utilize a memory function of the dielectric layer which covers the main electrodes. That is, an addressing is performed in a line scan mode so as to form a charged state in accordance with the contents to be displayed; next, a light sustain voltage Vs having alternating voltage polarities is applied concurrently to all the main electrode pairs. Then, surface discharges are generated along the substrate surface only in the cells having wall charges therein owing to an effective voltage, i.e. a cell voltage, exceeding the discharge firing voltage Vf. Short interval of the sustain voltages provides a visually continuous lighting state.

In the surface discharge type PDPs the long life can be expected by reducing the deterioration of the fluorescent material layer for the color display caused from ion bombardment during the discharge, by placing the fluorescent material layer on a back substrate opposite from the front substrate carrying the main electrode pairs. This type that the fluorescent material layer is coated on the back substrate is called a reflection type, while the other type where the fluorescent material layer is coated on the front substrate is called a transparent type. The luminous efficiency is advantageous in the reflection type where the front surface of the fluorescent material layer emits the light.

The dielectric layers are used not only for a simple insulating layer as of an LCD device, but also for storing electric charges for the AC drive as described above, and have been fabricated by a thick film method where a low-melting temperature glass paste is printed flat and is sintered. The dielectric constant and the thickness of the dielectric layer deternmines the firing voltage and the discharging current such that the thicker and the less dielectric constant provides the less capacitance allowing.the less discharging current. Accordingly, the dielectric layer is required to be thicker than a predetermined thickness. However, too thick a dielectric layer requires too high a firing voltage.

There has also been a problem in that the dielectric layer of the prior art thick film method generates bubbles during the firing process resulting in a difficulty in fabricating a uniform film entirely over the screen. The generated bubbles deteriorate the withstanding voltage between the main electrode and the address electrode. Moreover, in the reflection type PDP where the dielectric layer is located on the front substrate, the transparency is deteriorated by the bubbles resulting in less brightness through the front substrate.

Problems are moreover in that the high dielectric constant of the low melting point glass requires more electric power in charging the electrostatic capacitance between the electrodes; and causes thermal stress during the firing process as well. Reduced thickness of the dielectric layer may decrease the electrostatic capacitance between the electrodes; however, in coating the glass paste film the thinner layer is apt to cause undulation resulting in an increase in variation of the discharge characteristic, and may increase a fear of exposing the electrode.

Furthermore, the upper surface of dielectric layer 17p formed by a screen printing method or a spin coating method is almost flat regardless of rises and falls of the upper surface of the electrodes 41p & 42p on the substrate 11p as shown in FIG. 8 schematically illustrating a cross-sectional cut view of main portion of a prior art PDP. Accordingly, in the reflection type the thickness of the dielectric layer on the metal film 42p is thinner than that of the dielectric layer on the transparent electrode 41p, whereby a strong discharge is generated above the metal film 42p even though distant from the surface discharge gap. This discharge consumes the power with little contribution to the display light because the light of the discharge is shielded by metal film 42p.

In order to solve those problems some thin film methods have been attempted to form the dielectric layer. However, evaporation methods and a CVD (chemical vapor deposition) methods at normal pressure have failed to form the film of adequate thickness without cracks.

### SUMMARY OF THE INVENTION

It is a general object of the invention to provide a method to form a homogenous dielectric layer having a small dielectric constant, having a properly adequate thickness and leaving a proper thermal stress to the glass substrate, so as to be used in a gas discharge display device.

After main electrodes for generating a surface discharge therebetween are fabricated on a substrate, a dielectric layer is deposited on the substrate as well as on the electrodes a plasma chemical deposition method. The material of the dielectric layer is typically silicon dioxide. Thickness of the dielectric layer is 5 to 30 μm thick.

The above-mentioned features and advantages of the present invention, together with other objects and advantages, which will become apparent, will be more fully described hereinafter, with references being made to the accompanying drawings which form a part hereof, wherein like numerals refer to like parts throughout.

### A BRIEF DESCRIPTION OF THE DRAWINGS

FIG. 1 schematically illustrates an electrode arrangement of a PDP related to the present invention;

FIG. 2 illustrates a decomposition perspective view of baasic structure inside the PDP related to the present invention;

FIG. 3 schematically illustrates a cross-sectional cut view of main portions of the PDP related to the present embodiment;

FIG. 4 schematically illustrates a plasma CVD apparatus related to the present invention;

FIG. 5 schematically illustrates a cross-sectional cut view of main portions of the PDP related to the sixth preferred embodiment;

FIG. 6 schematically illustrates a cross-sectional cut view of main portions of the PDP related to the seventh preferred embodiment;

FIG. 7 schematically illustrates a display area of a PDP related to the seventh preferred embodiment; and

FIG. 8 schematically illustrates a cross-sectional cut view of main portions of a prior PDP.

### DESCRIPTION OF THE PREFERRED EMBODIMENT

First of all, general concept to reach the present invention is hereinafter described.

(1) The Properties, i.e. the Thickness and the Dielectric Constant, of the Insulating Film Upon the Electrode. If the thickness of the insulating film upon the electrode is thinner than a required value and/or the dielectric constant of the insulating film is high, the discharge current, i.e. the lighting, generated thereupon by the use of electric charges accumulated thereon becomes so strong that the luminous efficiency is deteriorated. In other words, the less discharge current provides the more luminous efficiency. This fact has been widely known. On the other hand, too large thickness and/or too small dielectric constant of the insulating film require too high a discharge firing voltage.

(2) Thermal Stress Remaining on the Insulating Film. The thermal expansion coefficient of the insulating film is smaller than that of the glass substrate deposited with the insulating film thereon. Accordingly, the glass substrate is warped when cooled after the deposition process. The amount of the warp have to be within a limit so that no cracks are generated in the insulating film and so that two glass substrates can be sealed together, and the warped substrates must be convex toward the opposite substrate.

The present invention is to provide a method and an insulating layer material to satisfy these requirements.

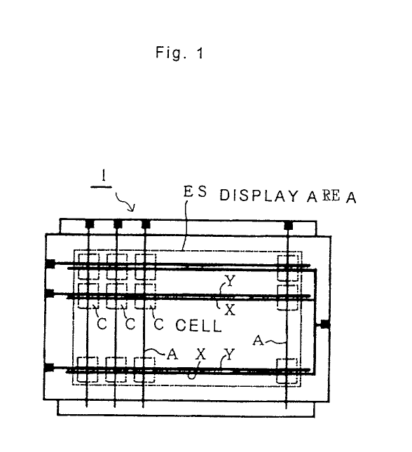

Detail of the present invention is hereinafter described representatively referring to plasma display panels. FIG. 1 schematically illustrates electrode arrangement of a PDP 1 in which the present invention is embodied.

PDP 1 is an AC type PDP of a three electrode surface discharge type where are arranged first main electrodes X and second main electrodes Y in pair in parallel, and address electrodes as third electrodes A to cross the main electrodes X & Y at each cell C. Main electrodes X & Y both extend along the line direction, i.e. the horizontal direction in FIG. 1, where the second main electrode Y is utilized as a scan electrode for selecting the cells line by line during an address period. Address electrodes A extend along the row direction i.e. the vertical direction in FIG. 1, and are utilized to select the cells row by row. An area in which the main electrodes and address electrodes are crossing each other is referred to as a display area, i.e. a screen, ES.

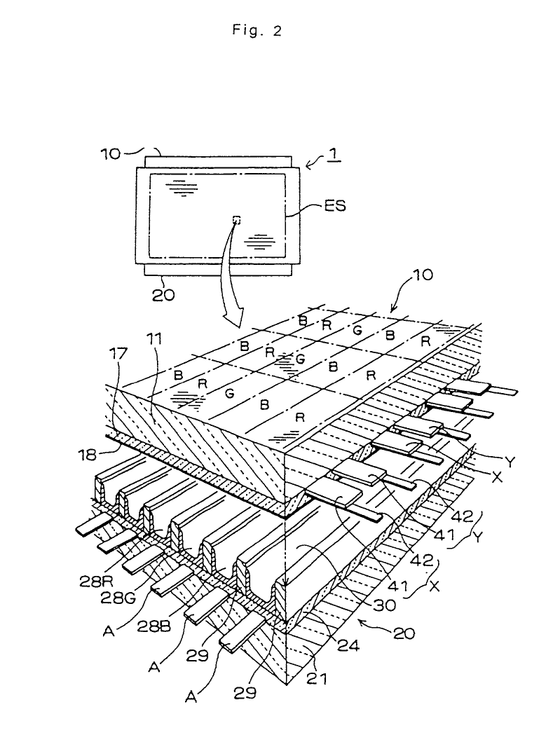

FIG. 2 schematically illustrates a decomposition perspective view of basic structure inside the PDP related to the present invention. PDP 1 is of a reflection type, and is formed of a pair of substrate structures 10 & 20. A pair of first and second main electrodes X & Y are arranged for each line upon an inner surface of glass substrate 11, which is a raw material of the substrate structure 10 of the front side. The line is formed of the cells aligned along the horizontal direction. First and second main electrodes X & Y are respectively formed of a stack of a typically 0.02 μm thick transparent conductive film 41 and a typically 3 μm thick metal film 42, which may be called a bus conductor, and are covered with a typically 10 μm thick dielectric layer 17. Upon the surface of dielectric layer 17 is provided a typically several angstrom thick protection layer 18 formed of magnesium oxide (MgO).

Address electrode A are arranged upon an inner surface of glass substrate 21, which is a raw material of the substrate structure 20 of the back side; and the address electrodes A are covered with a dielectric layer 24. Upon dielectric layer 24 is provided a typically 150 μm high separator wall in a shape of stripe in a plain view between adjacent address electrodes. Separator walls divide a discharge space 30 into sub-pixels, i.e. unit luminous area, along the line direction, as well as define the gap,_i.e. the height, of the discharge space.

Three fluorescent material layers 28R, 28G & 28B respectively of red, green & blue for the color display are provided so as to cover the inner surface of the back substrate, including above the address electrodes and the sides of the separator walls. The discharge space 30 is filled with a discharge gas, that is typically a mixture of xenon gas into neon gas which is the majority so that an ultraviolet light emitted in the discharge locally excites the respective fluorescent material layer to emit a light of the respective color. Thus, a single pixel, i.e. a picture element, of the display is formed with three sub-pixels respectively of the three colors aligning along the line direction. The structure in each sub-pixel is a cell, i.e. a display element. C. A space which corresponds to each row within the discharge space 30 is continuous along the row direction so as to cross over all the lines L.

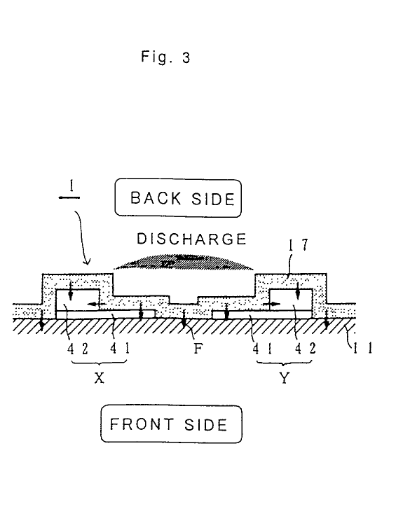

FIG. 3 schematically illustrates a cross-sectional cut view of main portion of a PDP of the present invention as a first preferred embodiment of the present invention. For an easy comprehension the dielectric layer structure 17 of the front side of PDP 1 is drawn on the lower side in the figure, and the protection layer is omitted therefrom. The same way is employed in the illustrations of main portion of the PDPs of the following preferred embodiments.

The PDP 1 is completed by sealing the front and back substrates together each fabricated with the structural elemments, and exhausted and filled with the discharge gas therein. A method according to the present invention to fabricate the dielectric layer 17 is carried out by the use of a plasma-enhanced CVD method, which is a kind of thin film formation methods, referred to hereinafter simply as a plasma CVD.

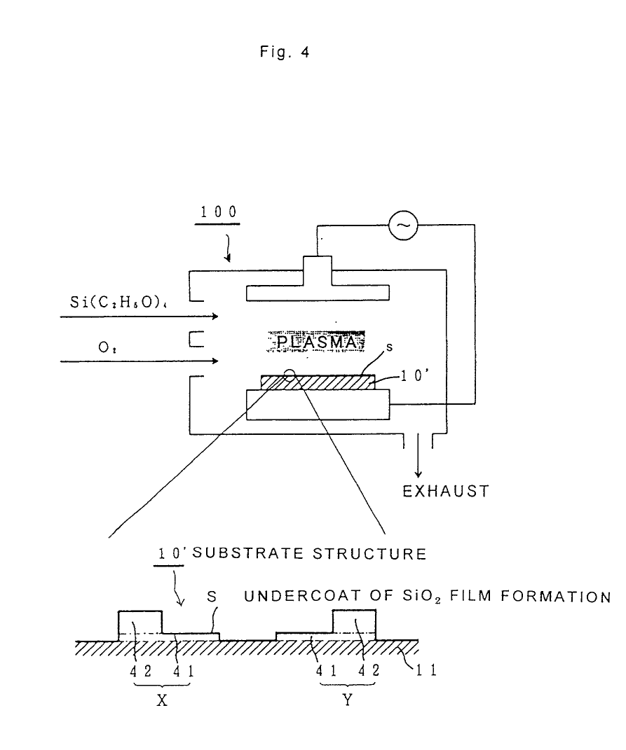

Referring to FIG. 3 and FIG. 4, a first preferred embodiment of the present invention is hereinafter described. Upon a substrate provided with transparent electrically conductive film 41 and metal film 42 is formed as thick as 10 μm SiO₂ (silicon oxide) film by the use of a plasma CVD apparatus 100.

A typical plasma CVD apparatus 100 used in the present invention is of a parallel plane electrode type, and is schematically illustrated in FIG. 4. A substrate structure 10′ on which the main X & Y electrodes have been arranged is placed in a vacuum chamber where plasma is generated from a source gas added with a reaction gas filled therein while applying a high frequency voltage between two electrodes_so that a SiO₂ film 17 is deposited according to the below-described condition on a soda lime glass substrate structure 10′ having the electrodes thereon. The material and the dimension of the glass substrate structure are shown in

TABLE 1

Glass Substrate Material: Soda Lime Glass

Sizes: 980 × 600 × 3 mm
Thermal Expansion Coefficient: 9 ppm

Main Electrodes:

Transparent Electrodes:

Material: ITO (indium tin oxide)
Thickness: 0.02 μm

Metal Film: Material Cr/Cu/Cr

Thickness: 0.1/2.0/0.1 μm

| | |
|---|---|
| Source Gas and its Flow Rate: | TEOS/800 SCCM |
| Reaction Gas and its Flow Rate: | O₂/2000 SCCM |
| Radio Frequency Power: | 1.5 kW |
| Substrate Temperature: | 350° C. |
| Vacuum: | 1.0 Torr |

where TEOS indicates tetra ethoxy silane, Si(C₂H₅O)₄.

10 minutes of this process yielded about 10 μm thick SiO₂ film conformally on the substrate as well as on each electrode.

Upon a sample silicon substrate as well was performed the same deposition process with the same conditions, in order to acquire comparison data.

Then it was found that thus formed SiO₂ films have a compression stress, −1.9×10⁹ dyn/cm² and −0.7×10⁹ dyn/cm² respectively for the soda lime glass and the silicon substrate.

On completion of the SiO₂ film, the substrate structure was in a warp to swell the deposited surface up as high as approximately 5 mm. This is because the thermal expansion coefficient of the SiO₂ film is larger than that of the soda lime glass substrate, accordingly the substrate tends to shrink more than the SiO₂ film when cooled after the deposition process. The thermal expansion coefficient of the deposited SiO₂ was calculated from the amount of the deformation and from the data aquired from the sample Si substate.

Next, upon thus formed SiO₂ film was deposited a typically 0.5 μm thick MgO film. Then, thus processed glass substrate is sealed with a back glass substrate separately prepared via low melting point glass paste.

The above mentioned warp, if within an appropriate amount, at the center towards the inner side of the PDP is preferable for keeping an equal gap between the two substrates after sealed together.

Luminous efficiency of thus fabricated PDP was measured 1.5 lm/w.

A second preferred embodiment employs other gases and conditions than those of the first preferred embodiment while employing the same plasma CVD apparatus so as to deposit SiO₂ on a soda lime glass substrate shown in TABLE 1 and on a sample silicon wafer.

| | |
|---|---|
| Source Gas and its Flow Rate: | SiH₄/900 SCCM |
| Reaction Gas and its Flow Rate: | N₂O/4000 SCCM |
| Radio Frequency Power: | 1.0 kW |
| Substrate Temperature: | 340° C. |
| Vacuum: | 1.2 Torr |

Thus deposited approximately 10 μm thick SiO₂ films during 8 minutes of the process had a compression, −0.2×10⁹ dyn/cm² and an −0.7×10⁹ dyn/cm² for the soda lime glass and the silicon substrate, respectively.

After an upper surface of the glass substrate was deposited with SiO₂ films, the glass substrate was in a warp to swell upward by approximately 1 mm at the central portion. The subsequent MgO deposition and the sealing process are the same as those of the first preferred embodiment. Luminous efficiency of the finished PDP was 1.5 lm/w.

A third preferred embodiment employed other gases and conditions shown below than those of the above first and second preferred embodiments while employing the same plasma CVD apparatus to deposit an organic silicon oxide (CH₃SiO) film on the soda lime glass substrate of TABLE 1.

| | |
|---|---|
| Source Gas and its Flow Rate: | Si(CH₃)₄/800 SCCM |
| Reaction Gas and its Flow Rate: | H₂O/4000 SCCM |
| Radio Frequency Power: | 2.0 kW |
| Substrate Temperature: | 400° C. |
| Vacuum: | 1.0 Torr |

Thus produced CH₃SiO film after 15 minutes of the process was approximately 10 μm thick, had a compression, −0.2×10⁹ dyn/cm² on the soda lime glass and had a specific dielectric constant 2.6. The warp swelling upward at the central portion was approximately 1 mm.

The substrate structure formed with thus produced CH₃SiO film was coated with a 0.5 μm thick MgO film and was sealed with a back substrate by the same way as those of the above preferred embodiments so as to complete a PDP, where the luminous efficiency was measured 1.7 lm/w.

A fourth preferred embodiment employed other gases and conditions shown below than those of the above-described preferred embodiments while employing the same plasma CVD apparatus to deposit a silicone nitride (SiN) film on the same soda lime glass substrate of TABLE 1 and on a sample silicon substrate.

| | |
|---|---|
| Source Gas and its Flow Rate: | SiH₄/1000 SCCM |
| Reaction Gases and the Flow Rate: | N₂/3200 SCCM |
| | NH₃/8000 SCCM |
| Radio Frequency Power: | 1.0 kW |
| Substrate Temperature: | 400° C. |
| Vacuum: | 2.6 Torr |

Thus produced SiN film after 20 minutes of the process was approximately 10 μm thick, had a compression, −0.8×10⁹ dyn/cm² on the Si substrate, and a specific dielectric constant 7.0. Thus deposited soda lime glass was processed so as to be sealed with the back substrate by the same way as the above-preferred embodiments to complete a PDP. The luminous efficiency of the completed PDP was measured 1.1 lm/w.

A fifth preferred embodiment employed other gases and conditions shown below than those of the above first to third preferred embodiments so as to deposit a SiO₂ film on the soda lime glass substrate of the material shown TABLE 1 but of the dimension 320×200×2 mm thick. The warp was 4 mm to successfully allow the sealing with the back substrate.

| | |
|---|---|
| Source Gas and its Flow Rate: | SiH₄/900 SCCM |
| Reaction Gas and its Flow Rate: | H₂O/10,000 SCCM |
| Radio Frequency Power: | 2.0 kW |
| Substrate Temperature: | 340° C. |
| Vacuum: | 1.2 Torr |

In order to acquire first reference data, SiO₂ films, i.e. hot CVD films, were formed respectively on an a silicon substrate and on a soda lime glass each of the first preferred embodiment and of TABLE 1 by the below described conditions employing the CVD apparatus 100.

| | |
|---|---|
| Source Gas and its Flow Rate: | SiH₄/900 SCCM |
| Reaction Gas and its Flow Rate: | H₂O/6000 SCCM |
| Radio Frequency Power: | 0 kW |
| Substrate Temperature: | 450° C. |
| Vacuum: | 0 atmospheric pressure |

Thus produced SiO₂ film after 100 minutes of the process was approximately 10 μm thick, had a tension +2.3×10⁹ dyn/cm² on the soda lime glass and a compression +4.0 had a specific dielectric constant 2.3×10⁹ dyn/cm² on the silicon substrate. However, there were generated many cracks on the film; accordingly, it was impossible to seal the two substrates to complete a PDP.

In order to acquire second reference data, an approximately 10 μm thick SiO₂ films were formed respectively on an a silicon substrate and on a soda lime glass each of the first preferred embodiment and of TABLE 1 by the below-described conditions employing the same CVD apparatus 100 as the first preferred embodiment.

| | |
|---|---|
| Source Gas and its Flow Rate: | SiH₄/900 SCCM |
| Reaction Gas and its Flow Rate: | N₂O/5000 SCCM |
| Radio Frequency Power: | 1.8 kW |
| Substrate Temperature: | 380° C. |
| Vacuum: | 0.7 Torr |

Thus produced approximately 10 μm thick SiO₂ film after 9 minutes of the process had a compression −4.6×10⁹ dyn/cm² on the soda lime glass and a tension +4.0×10⁹ dyn/cm² on the silicon substrate. However, the warp to swell toward the upper side was as high as approximately 12 mm, which was too much to allow the substrate to be sealed with the back substrate.

As shown in FIG. 3, metal film 42 has been placed at a transparent electrically conductive electrode 41's side opposite from the surface discharge gap. Accordingly, advantageous effect of the above-described preferred embodiments are particularly in that dielectric layer 17 is of a low dielectric constant, and homogeneously and conformally covers the first and second main electrodes X & Y. Moreover, the advantage is in that the SiO film generates a compression stress indicated with arrows FIG. in the figures, and includes no bubble. Thus conformal thickness of the dielectric layer above the electrodes allows its surface to follow the heights of the underling electrodes as shown in the figure. Accordingly, the undesirable discharge described above with FIG. 8 is difficult to take place through the locally thin dielectric layer above the metal electrode 42, whereby it is easy to provide an appropriate discharge range by selecting the driving voltages. 36 In order to acquire third_reference data employing a prior art thick film method to form the dielectric layer, flit glass of a low-melting temperature glass containing PbO—BO—SiO was printed as thick as approximately 30 μm by the use of a screen printer on the same glass substrate and on the same substrate structure as the first preferred embodiment shown in TABLE 1. The substrate and the substrate structure were fired at 580° C. in an air atmosphere in a continuous furnace for 60 minutes. Thus produced glass layer included very many air bubbles. The specific dielectric constant was measured 12.0. Thus fabricated substrate structure was coated with a 0.5 μm thick MgO was sealed with the back substrate structure so as to complete a PDP in the same way as the above preferred embodiments. The luminous efficiency was measured 0.8 lm/w.

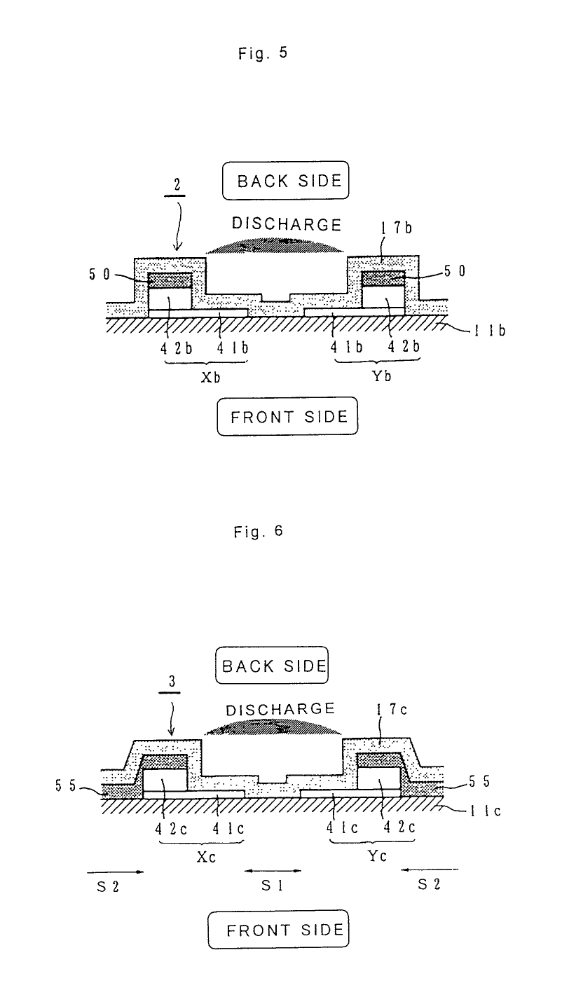

An electrode structure of a sixth preferred embodiment of the present invention is hereinafter schematically illustrated with reference to a second PDP 2 shown in FIG. 5. After the first and second electrode main electrodes are formed with the transparent conductive electrode 42a stacked with a metal film 42b thereon, but before forming the first dielectric layer 17b by the thin film_method, upon a top of metal layer 42b of each main electrode Xb & Yb.is arranged a second dielectric layer 50 typically formed of a low-melting point glass typically and of typically 10 μm thickness by a method of silk screen printing and is fired to melt, and then first dielectric layer 17c is formed upon all over the surface of the glass substrate including the electrodes 41b & 41b and second dielectric layer 50. Thus added second dielectric layer 50 on the metal electrode 42b makes the thickness of the dielectric layers on the metal electrode 42b is thicker than other part of the main electrodes Xb & Yb so as to reduce the capacitance between the upper surface of the first dielectric layer 17a and the metal electrode 42b; accordingly reduces the wall charges to be generated above the metal electrode so that the unnecessary surface discharge generated above the metal electrode is supressed. It has been well known that in a glow discharge the brightness and its luminous efficiency are not compatible with each other, that is the reduction of the unnecessary surface discharge less concentrated above the metal electrode increases the luminous efficiency of the PDP.

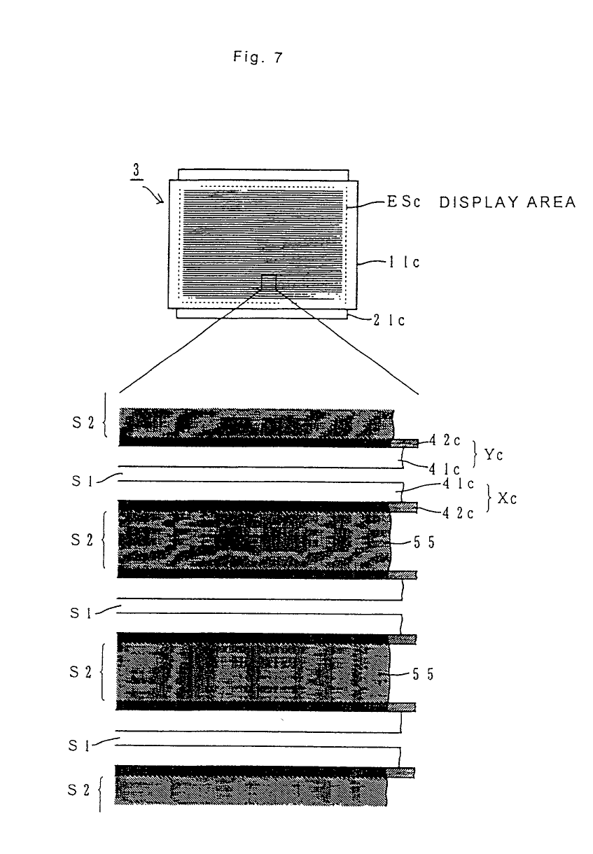

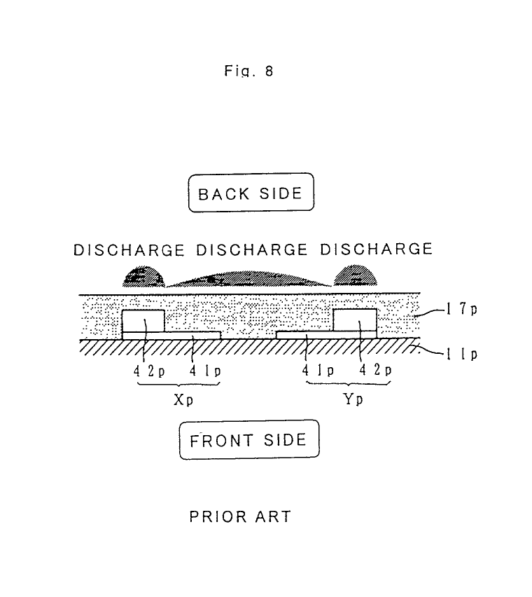

An electrode structure of a fifth preferred embodiment of the present invention is hereinafter schematically illustrated with reference to a third PDP 3 shown in FIG. 6. In fabricating third PDP 3, after forming main electrodes Xc & Yc by sequentially depositing transparent electrode 41c and metal film 42c on front glass substrate 11c and before forming dielectric layer 17c with the thin film according to the above-described preferred embodiments, a third dielectric layer 55, typically formed of glass typically including chrome oxide, iron oxide and manganese oxide, of a dark color, such as black, is arranged so as to cover metal electrode 42c and a reverse slit S2, where the reverse slit is a gap S2 between main electrodes respectively of adjacent lines and is wider than the main electrode gap S1 for generating the surface discharge in each line. Third dielectric layers 55 form a shielding pattern of stripes throughout the entire display area ESc as shown in FIG. 7 so as to hide fluorescent material layer existing between the lines, resulting in an enhancement of the display contrast. Moreover, the third dielectric layer covering metal electrode 42c produces a thicker layer than the other portion of the main electrodes Xc & Yc, accordingly the unnecessary discharge to be generated above metal electrode 42c is suppressed so as to enhance the luminous efficiency in the same way as described in the fourth preferred embodiment.

Though in the above-described preferred embodiments the deposited dielectric layer was described to be typically 10 μm thick, the thickness may be chosen 5 to 30 μm as long as the other requirement can be satisfied, such as the amount of the warp and the firing voltage of the surface discharge, etc.

According to the fabricating method of the present invention, the dielectric layer 17, 17b & 17 can be formed at a temperature lower than the case where the dielectric layer is formed by a firing method for which the glass substrate must be fired at a high temperature. Whereby, the heat stress in the glass substrate can be reduced.

The many features and advantages of the invention are apparent from the detailed specification and thus, it is intended by the appended claims to cover all such features and advantages of the methods which fall within the true spirit and scope of the invention. Further, since numerous modifications and changes will readily occur to those skilled in the art, it is not detailed to limit the invention and accordingly, all suitable modifications are equivalents may be resorted to, falling within the scope of the invention.

We claim:

1. A fabricating method of a gas discharge display device having a dielectric layer spreading over an entire display area so as to cover electrodes arranged on a substrate, comprising the steps of:
arranging the electrodes on the substrate; and
forming homogeneously and conformally the dielectric layer upon a surface of the substrate, on which the electrodes have been arranged, by the use of a plasma vapor deposition method.

2. A fabricating method of a gas discharge display device having a dielectric layer spreading over an entire display area so as to cover main electrodes arranged to form an electrode pair for causing a surface discharge, the main electrodes being constituted of a stack of a tranparent electrode and a metal electrode thereon on a substrate, comprising the steps of:
arranging the electrodes on the substrate; and
forming, upon a surface of the substrate on which the electrodes are arranged, conformally the dielectric layer by the use of a plasma vapor deposition method.

3. A fabricating method of a gas discharge display device as recited in claim 2, further comprising the step of:
forming an insulating layer for partially covering respective one of the main electrodes before said step of forming the dielectric layer.

4. A fabricating method of a gas discharge display device as recited in claim 2, further comprising the step of:
forming a light shielding layer between the electrodes excluding the surface discharge gap within the display area before forming the dielectric layer.

5. A fabricating method of a gas discharge display device as recited in either one of claims 1 and 2, wherein the dielectric layer is formed of a silicon compound.

6. A fabricating method of a gas discharge display device as recited in either one of claims 1 and 2, wherein the dielectric layer is formed of a layer having a compression stress.

7. A fabricating method of a gas discharge display device as recited in either one of claims 1 and 2, wherein thickness of said dielectric layer is 5 to 30 μm thick.

8. A fabricating method of a gas discharge display device as recited in either one of claims 1 and 2, wherein a residual stress of the film is compressive when the film forming process is finished.

9. A fabricating method of a gas discharge display device having a dielectric layer spreading over an entire display area so as to cover electrodes arranged on a substrate, comprising the steps of:
arranging the electrodes on the substrate; and
forming the dielectric layer upon a surface of the substrate, on which the electrodes have been arranged, by the use of a plasma vapor deposition method.
